(19) United States
(12) Patent Application Publication
(10) Pub. No.: US 2012/0150697 A1
(43) Pub. Date: Jun. 14, 2012

(54) METHODS THAT ALLOW MULTIPLE RETAILERS THE ABILITY TO PARTICIPATE IN RESTRICTED SPEND CARD PROGRAMS WITHOUT MANAGING MULTIPLE CATALOGS OF ELIGIBLE ITEMS ASSOCIATED WITH MULTIPLE CARD PROGRAMS

(76) Inventor: Devin Wade, Redwood City, CA (US)

(21) Appl. No.: 13/117,010

(22) Filed: May 26, 2011

Related U.S. Application Data
(60) Provisional application No. 61/422,507, filed on Dec. 13, 2010.

(51) Int. Cl. G06Q 30/00; G06Q 40/00

(52) U.S. Cl. 705/27.2; 705/44

(57) ABSTRACT

A method is provided for multiple retailers to participate in restricted spend financial transaction card programs. A restricted spend financial transaction card system is provided that includes an adjudication processor system coupled to a retailer infrastructure. The adjudication processor system includes a switch, a market basket analysis server and a process control server. The market basket analysis server is used to validate items in a market basket. Content attributes of the market basket are communicated from the market basket analysis server to the switch. The switch, market basket analysis server, a catalog management server and the process control server are used for adjudication.

### RELATED APPLICATION

This application claims the benefit of U.S. Ser. No. 61/422,507, filed Dec. 13, 2010, which application is fully incorporated herein by reference.

### BACKGROUND

1. Background of the Invention

The present invention relates generally to methods for facilitating multiple retailers to participate in restricted spend programs, and more particularly to methods that enable multiple retailers to participate in restricted spend card programs without the need to maintain the list of approved items, thus saving significant labor expense.

2. Description of the Related Art

Many managed healthcare providers offer their buyers discounts on prescription drugs. However, only a few managed healthcare providers also offer their buyers discounts for Over-The-Counter (OTC) drugs. Therefore, it is common for buyers to visit the emergency room for ailments such as runny noses and coughs. These visits and often the pharmaceuticals prescribed during these visits are typically very expensive and are often covered by the managed healthcare providers.

Many of these visits and their associated costs could be eliminated if the buyers were given a fixed monthly dollar amount to spend on OTC products, such as OTC cough syrups, antihistamines, aspirins, etc. The few managed healthcare providers that offer OTC benefits to their buyers have traditionally attempted to accomplish an offer by using paper vouchers or forms that were given to the buyers and redeemed at the retail stores. These traditional methods were often fraught with mistakes and did not provide the ability to offer any reporting capabilities associated with the methods.

In one system and method for facilitating redemption of benefits for a buyer, a financial transaction card is provided that includes associating an identification code with the buyer. The identification code is stored on the financial transaction card. An account record associated with the identification code is accessed and a determination is then made to ascertain if an item presented for purchase by the buyer is eligible for a financial discount. An appropriate discount for the item is calculated if it is determined that the item is eligible for a financial discount.

Current methods address multiple entities relative to managed care providers and a plurality of entities in terms of retailers, but fail to provide for the complexities inherent in a many-to-many scenario of creating, associating and managing eligible item list(s). A single managed care organization and one item list plus a single retailer brand is fairly straightforward. However, multiple organizations with more than one item list accepted at multiple retailers are a more complex scenario. With current methods, the list itself is identified. However, current methods fail to create, associate and manage the list even though the resulting output of the list is necessary in order to perform the item match at point of purchase based on the presenting payment or ID mechanism.

Most U.S. health plans provide benefit coverage for healthcare related OTC items at retail stores. Examples include, but are not limited to, allergy medications, cough and cold remedies, pain relievers, vitamins, and the like.

The Federal government, through the Department of Health and Human Services, and more specifically Centers for Medicare and Medicaid restrict the use of benefit funds being directed to one retailer brand (Merchant); requiring many retailer brands to offer the benefit. Also, the Federal government does not restrict a retailer in terms of what items are offered, so long as the items are a subset of the overall approved list and that they are offered to all buyers.

Current methods do not address how eligible item list(s) are created, associated with a card program and managed on an ongoing basis. Current methods only address that the item presented for purchase by the buyer is determined to be eligible or non-eligible based on a list; a list provided by a managed care provider or employer in the example of a flex benefit card.

There is a need for systems and methods that allow several retailers to participate in restricted payment programs created by several health plans (or sponsors), without having the burden of managing the multiple lists of eligible items. There is a further need for systems and methods that allow several retailers to participate in restricted payment programs created by several health plans without having the burden of executing the rules associating with each item from several lists with a customer purchasing items at their store in real-time.

### SUMMARY

An object of the present invention is to provide methods that enable multiple retailers to participate in restricted spend financial transaction card programs without the need to maintain the list of approved items, thus saving significant labor expense.

Another object of the present invention is to provide methods that enable multiple retailers to participate in restricted spend financial transaction card programs without the retailer being responsible for the accuracy of the content of the approved item lists, thus eliminating business and compliance risks.

A further object of the present invention is to provide methods that more readily allow retailers to participation in numerous restricted spending programs.

Yet a further object of the present invention is to provide methods for health plans that offer a large number of targeted, restricted spend programs to enhance their product and service offerings.

Accordingly, an object of the present invention is to provide methods that enable multiple retailers to participate in restricted spend financial transaction card programs without having to manage multiple catalogs of eligible items associated with multiple financial transaction card programs.

Another object of the present invention is to provide methods that enable multiple retailers to utilize a near real-time method for obtaining current information regarding approved item lists.

Another object of the present invention is to provide methods that allow multiple retailers to utilize an in-line analysis server that analyzes item eligibility against stored item list data.

Another object of the present invention is to provide methods that allow multiple retailers to utilize an in-line financial approval request to be forwarded and processed by any payment issuer for the items adjudicated as approved.

Another object of the present invention is to provide methods for creating a pharmacy script from data generated from a point-of-sale transaction at retailers.

Another object of the present invention is to provide for the creation and management of item lists with unique identification codes for each item that correspond to items approved by a sponsor as eligible for payment utilizing the sponsor's financial transaction card.

These and other objects of the present invention are achieved in a method for multiple retailers to participate in restricted spend financial transaction card programs. A restricted spend financial transaction card system is provided that includes an adjudication processor system coupled to a retailer infrastructure. The adjudication processor system includes a switch, a market basket analysis server and a process control server. The market basket analysis server is used to validate items in a market basket. Content attributes of the market basket are communicated from the market basket analysis server to the switch. The switch, market basket analysis server, a catalog management server and the process control server are used for adjudication.

### BRIEF DESCRIPTION OF THE DRAWINGS

FIG. 1 is an overall system architecture of one embodiment of the present invention outside of a retailer network infrastructure.

FIG. 2 is an overall system architecture of one embodiment of the present invention inside a retailer network infrastructure.

FIG. 3 is a flow chart illustrating operation of a market basket analysis server used in one embodiment of the present invention.

FIG. 4 is a flow chart illustrating market basket adjudication in one embodiment of the present invention.

FIG. 5 is a flow chart illustrating the operation of a switch of an adjudication processor in one embodiment of the present invention.

### DETAILED DESCRIPTION

Systems and methods are provided for facilitating multiple retailers to automate the process of matching items presented at point of purchase 16 with the buyer selected financial transaction card to determine if the items presented are permitted to be purchased by the presented financial transaction card. More particularly, the present invention provides for the matching of items to multiple item lists for sponsor associated payment/settlement programs.

With the present invention, systems and methods are provided for implementing a financial transaction card program having buyers. The buyers are restricted to purchase select items from select merchants and the merchants are part of a private host-to-host network having the ability to communicate messages to and from a network computer. Each buyer has a unique identification code that corresponds with a list of selected items and a list of selected merchants.

With the present invention, systems and methods are provided to implement an adjudication process which allows a market basket utilized with product catalogs. Each catalog contains a list of Universal Product Codes (“UPC”), each identifying an item that can be purchased by a financial transaction card, also called a spending purse. A purse is an identifier for a financial account. As non-limiting examples, the financial account can be a bank account, credit card, debit card, pre-paid card, a third party funding source and the like. As non-limiting examples, a financial transaction card can be, the financial transaction card is selected from at least one of, credit financial transaction card, debit financial transaction card, gift financial transaction card, fund transfer financial transaction card, other types of payment authenticating piece capable of carrying out a transfer of funds and the like In one embodiment, a financial transaction card, including but not limited to a debit or credit card, has multiple financial transaction institutions or purses. The card can also have only one spending purse. Items in the market basket are adjudicated against the one or more associated catalogs.

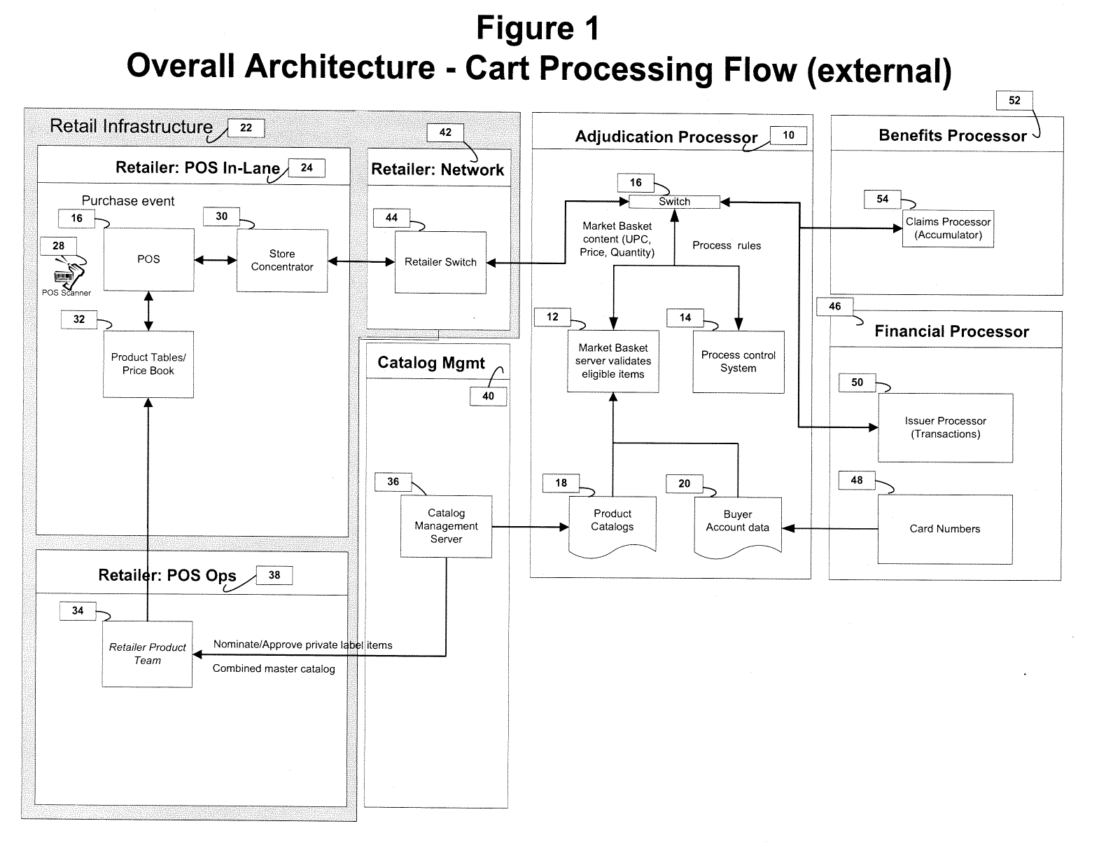

As illustrated in FIG. 1, an adjudication processor 10 includes a market basket analysis server 12, a process control server 14, a switch 16, product catalogs 18 and buyer account data 20.

More generally, in FIG. 1, a retailer infrastructure, denoted as 22, includes a retailer:POS In-Lane 24, hereafter (retailer 24). The retailer 24 includes a point of sale server (POS) 26, with a bar code scanner 28, that is coupled to a store concentrator 30 and to a product tables/price book(s) 32. A retailer product team 34 is in communication with the product tables/price book(s) 32 and to a catalog management server 36. The retailer product team 34 is part of a retailer:POS Ops 38.

The catalog management server 36 is included in a catalog management processor 40. The retailer infrastructure 22 also includes a retailer network 42 with a retailer switch 44.

The retailer switch 44 is coupled to the adjudication processor 10. The market basket analysis server 12 is coupled to the product catalogs 18 and validates eligible items in the market basket, as more fully discussed hereafter. The contents of the market basket, including but not limited to, UPC, price, quantity and the like, are communicated between the market basket analysis server 12 and the switch 16, from the retailer switch 44. The catalog management server 36 communicates with the market basket analysis server 12 in the form of the product catalogs 18.

A financial transaction card issuer, hereafter (financial processor 46) is coupled to the adjudication processor 10 and includes financial transaction card numbers 48 and an issuer processor (transactions) 50.

A benefits processor 52 includes a claims processor (accumulator) 54 coupled to switch 16. The benefits processor 52 is in communication with the switch 16. The market basket analysis server 12 can contact the benefit processor 52 via the switch 16 in real time and receive a claim authorization. The benefits processor 52 can communicate via standard prescription languages, NCPDP5.1 and NCPDP d.0.

Account information 56 includes buyer account data 20 that is provided to the market basket analysis server 12 and relates to financial transaction card numbers 48, originating with the financial processor 46 that includes an issuer processor 50 (transactions). The issuer processor 50 communicates with a switch 58 and to switch 16 where financial approval transactions are required.

As previously recited, the present invention facilitates multiple retailers to automate the process of matching items presented at POS 26 purchase with the buyer selected payment mechanism to determine if the items presented are permitted to be purchased by the presented payment mechanism. More particularly, the present invention provides for the matching of items to multiple item lists for sponsor associated payment/settlement programs.

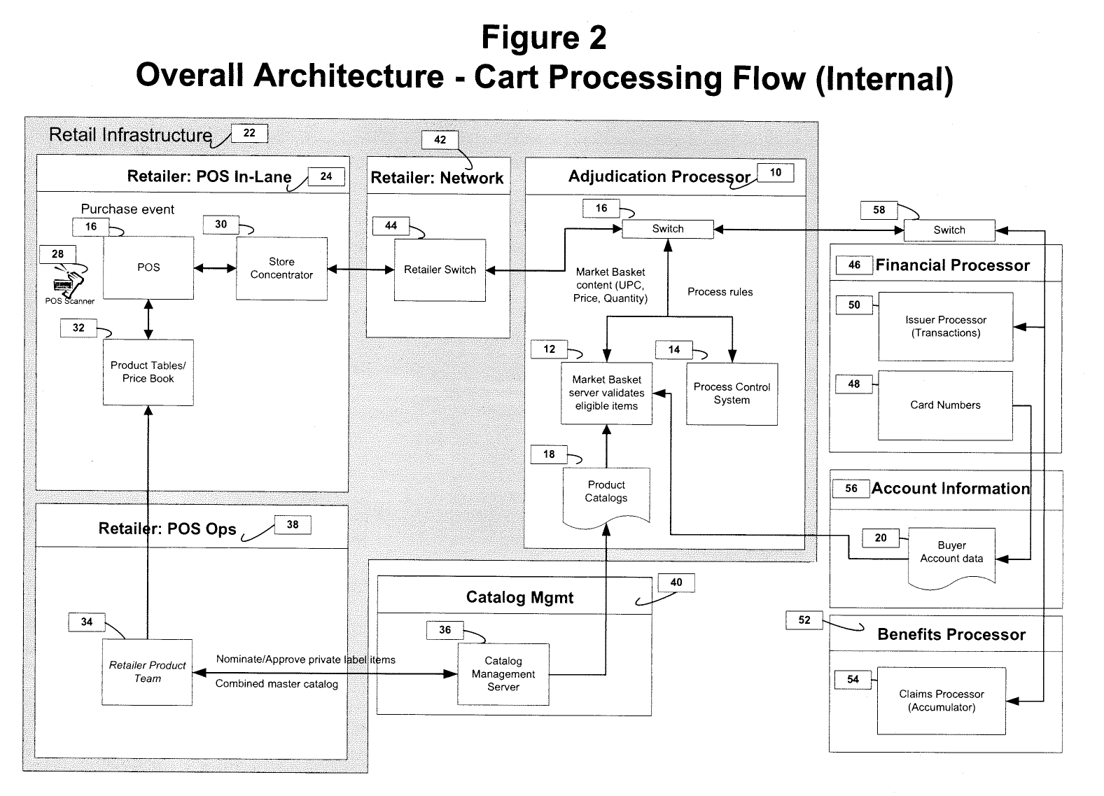

In the FIG. 2 embodiment, the adjudication processor 10 is included in the retail infrastructure 22. The overall system architecture in the FIG. 2 embodiment includes switch 58 to communicate with retailer processes that are behind the retailer firewall.

The adjudication process utilizes components in the adjudication processor 10. In combination, the switch 16, market basket analysis server 12, catalog management server 36, and the process control server 14 provide adjudication. In one embodiment, the adjudication process also can authorize the financial transaction.

Financial transactions that are triggered by a retailer in-lane purchase activity are typically communicated in the form of ISO 8583 from the retailer switch 44 to the switch 16. The switch 16 decomposes the ISO 8583 message into messages suitable for processing by subsequent processing components, such as the market basket analysis server 12.

In one embodiment, the switch 16 communicates the market basket content data and transaction identification information to the market basket analysis server 12, in the data form that has been parsed and formatted by the switch 16.

The market basket analysis server 12 compares the market basket contents to the product catalog(s) 18. Product catalog(s)18 have been previously loaded to market basket analysis server 12 from catalog management server 36. Product catalogs 18 contain an items list of approved products, identified by UPC and short description. Market basket line item content data is processed iteratively by the market basket server 12.

With the present invention, adjudication to a plurality of catalogs 18 can be processed. With the present invention, a catalog 18 is directly related to an account purse. This purse can be associated to a restricted spend based upon the catalog 18 that is used to adjudicate an item list. For example, a financial transaction card may support spending against a food items catalog and also an over-the-counter drug item catalog. One or more spending purses, each with a specific spending balance from a specific Issuer may be identified to a single financial transaction card.

With the present invention, the retailer 24 collects the market basket and upon a swipe or scan of a buyer's financial transaction card, packages up the market basket sends it to the adjudication processor 10 with either, (i) the retailer processing the purchase request, or (ii) the adjudication processor processing the purchase request. Incoming and outgoing communications between the retailer 24 and the adjudication processor 10 can via an ISO 8583 message format, an XML web services format, and the like, all as real time interchanges. As a non-limiting example, entering can be done by at least one of, swiping the financial transaction card through a slot of a card reader coupled to the mobile device, through a slot of the mobile device, scanning, through wireless communication, touch of the financial transaction card to the mobile device, by typing in information at the mobile device, photos, selecting a financial transaction card from an application on a mobile device and from an on-line entity.

As illustrated in FIGS. 1 and 2, the retailer communicates with the retailer switch 44 which pushes transaction data to the adjudication processor 50. The switch 16 receives the transaction and processes it to conclusion. The switch 16 is the gateway for all types of transactions. A transaction may be one of many types. In one embodiment of the invention a transaction may be an adjudication request, an authorization request, or a POS result transaction. The switch 16 determines the nature of the transaction request 56 and formats data and routes the request through subsequent processes as determined by the type of request.

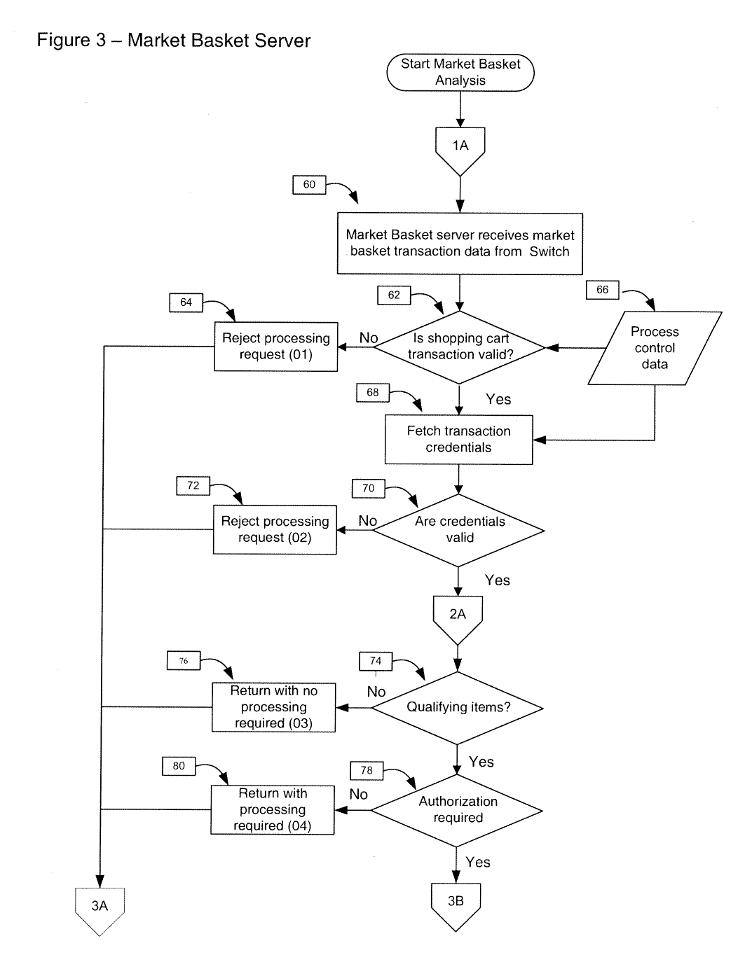

FIG. 3 is a flow chart illustrating operation of the market basket server 12 with steps 60-80. The market basket analysis server receives market basket transaction data from the switch 16 and determines if the market basket transaction is valid. If it isn't, then the processing request is rejected. If it is valid, then the market basket server 12 retrieves transaction credentials from process control data. If the credentials are not valid then the processing request is rejected. When the credentials are valid, a determination is made to see if there are qualifying items from the market basket. If not then the there is a return with no processing required. If yes, authorization is required and then returned with processing required.

The adjudication transaction contains transaction identification and market basket information as formatted and forwarded to the market basket server process. The authorization transaction contains transaction identification and requests for financial authorization against a specific financial payment account (purse). The result transaction contains transaction identification information, processed market basket adjudication transaction (market basket items flagged to a specific purse and catalog), and financial authorization information.

The market basket server 12 receives an adjudication transaction from the switch 16. The market basket server 12 processes the entire financial transaction card to the extent possible and returns the transaction result to the switch for further processing as required. The switch 16 receives the adjudication transaction and determines if further processing is required. The adjudication transaction may require that the switch 16 obtain financial transaction authorization from one or more issuers. The switch 16 formats the transaction information 60 for routing and processing by the issuer.

The switch 16 waits to complete a transaction to the retailer 24 until authorization request(s) are processed and returned by the issuer(s). Authorization information is formatted and returned to the retailer 24 and the transaction is added to a permanent data log of all transactions passing through the switch 16. The switch 16 formats POS result transaction and returns to the retailer 24 and the transaction is added to a permanent data log of all transactions passing through the switch 16.

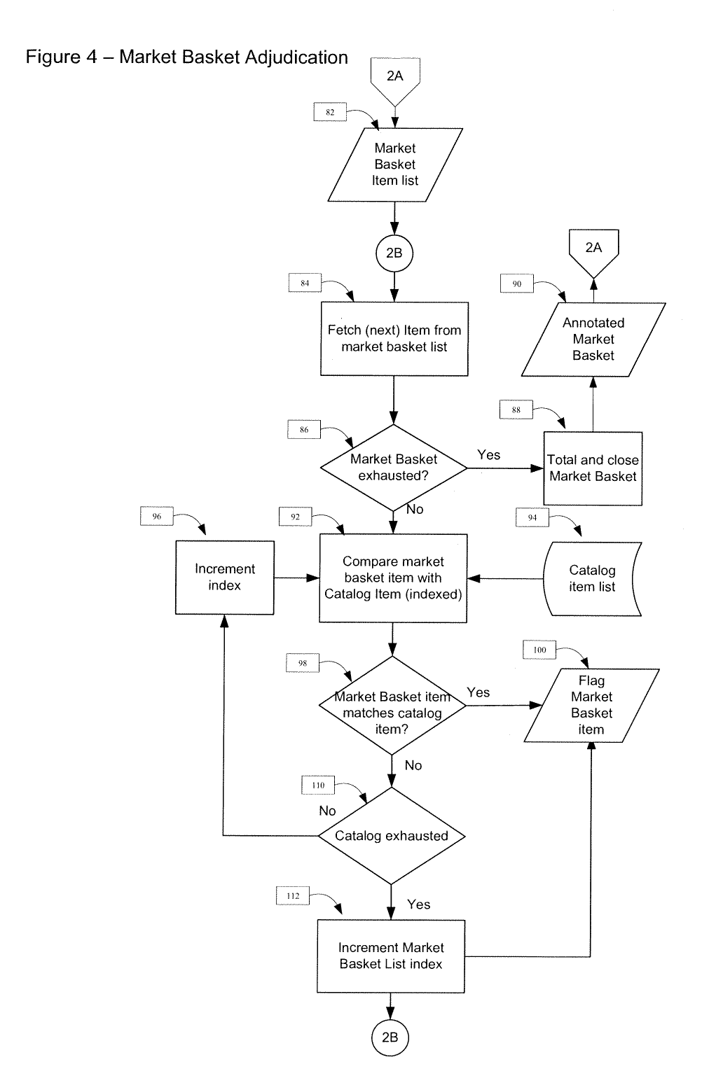

Referring to the market basket adjudication flow chart of FIG. 4 with steps 82 through 112, the market basket item list is received using the market basket analysis server 12 and the switch 16. When the market basket is exhausted a total is made of the items, the market basket is closed, and an annotated market basket created. If it is not exhausted then items from the market basket are compared with indexed catalog items. When there isn't a match with catalog items the catalog 18 is exhausted and an index incremented. Then the catalog 18 is not exhausted the market basket list index is incremented and the item is flagged.

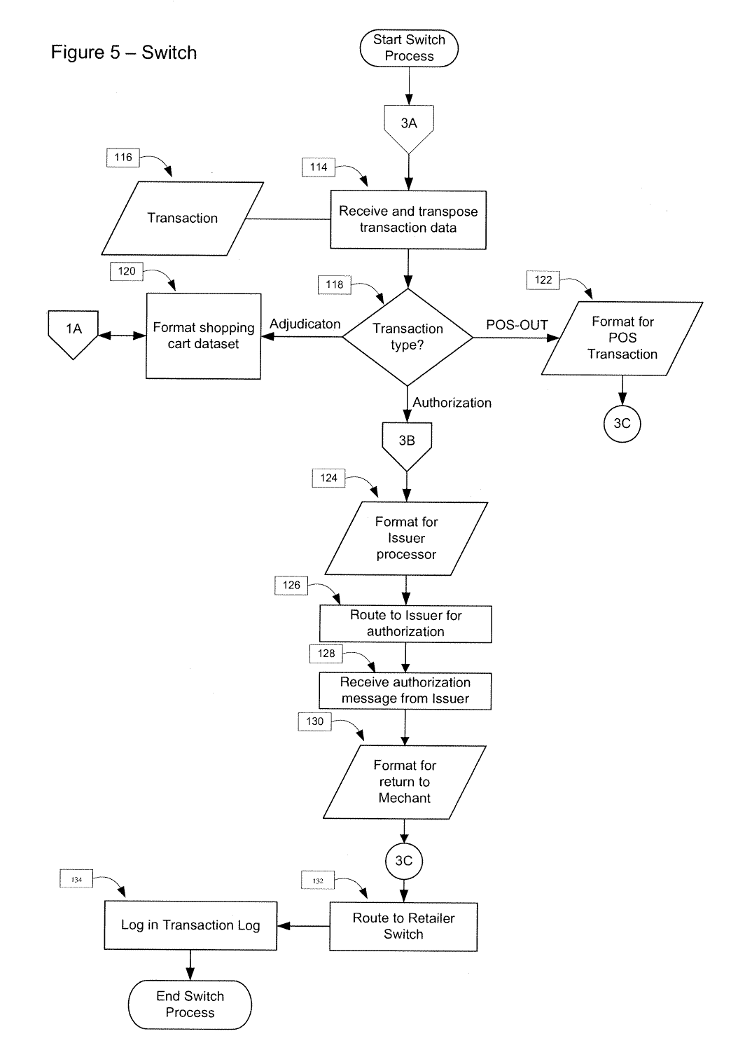

The operation of the switch 16 is illustrated in FIG. 5 in steps 114 through 134. The switch 16 receives and transposes transaction data received from a transaction. A determination is made by the switch 16 as to the type of transaction. When the transaction is adjudication, the market basket is formatted. For a POS-OUT transaction, it is formatted for POS. The switch 16 then performs authorization, formats the transaction for the financial processor 46 and then routes 508 to the issuer for authorization. An authorization message 509 is received from the financial processor 46. The switch 16 formats this and returns it to the retailer 24 via the retailer switch 44. The transaction is then logged in a transaction log.

There are multiple authorizations for multiple purses. The switch 16 is configured to couple to multiple financial processors 40 when there are multiple authorizations. The switch 16 can couple to multiple financial processing systems, to process restricted spending against multiple purses tied to multiple issuer processors. Based upon rules provided by the process control server 14, the switch bifurcates the financial transactions to multiple financial card issuers and receives authorization from multiple financial processors.

With the present invention the market basket analysis server 12 isolates a buyer's financial account information from the reliance for regulatory compliance of HIPAA and PCI-DSS.

The retailer 24 is isolated from the details of multiple purses, multiple financial transaction card issuers member demographics and the like. The PAN of a transaction ties to an account structure that defines the applicable process control rules. Process control rules are provided to the switch 16 from the process control server 14, to establish the path of the financial authorizations. A financial transaction card number 48 and associated catalogs 18 with that financial transaction card are provided in order for the market basket analysis server 12 to use the catalogs with a purse.

The adjudication processor 10 does not send the retailer member demographics. A financial transaction card number 48 and associated catalogs 18 with that financial transaction card are provided in order for the market basket analysis server 12 to use the catalogs related to the PAN, financial transaction card issuers, and purses.

With the present invention the following steps are taken.

A collection of item data is received, e.g., the market basket. Each item in the market basket has a universal product code (“UPC”) to uniquely identify the item and has a quantity, net price and added tax as determined by the retailer price list.

Each item in a market basket is evaluated and compared by the UPC to items approved for the specific purse as related to the product/plan product catalog 18. Each item in the market basket is marked as eligible or ineligible to a specific product/plan. Eligible items are grouped according to a product/plan and a calculation is made of a total cost of all items, less appropriate discounts and allowances, for each group. Items, group totals, and market basket identification information is formatted into XML data structures, ISO8583, NCPDP 5.1 or NCPDP d.0, for further processing by the retailer 24, benefit processor 52 and the like.

Adjudication can be hosted at a retailer 24 and be internal to the retailer, or adjudication can be hosted external to the retailer and have several retailers connecting to it.

XML data structure is pushed to the switch 16. The switch 16 is utilized to translate data in the retailer specified format for systems hosted within the retailer network and into ISO8583, XML, NCPDP 5.1 or NCPDP d.0 formats for processing by issuer processor 50 or claims processor 54. An XML-based financial authorization request or ISO8583 based financial authorization request is initiated where the financial processor is not integral to the internal retailer network, and where the retailer requires that transactions be initiated by the present invention. In this instance, the system and method of the present invention process control server 14 determines the content of the authorization request against group totals and the switch 16 builds and transmits XML-based authorization requests to the financial processor 46. The switch 14 formats XML-based authorization requests in formats required by the corresponding issuer processor.

Items selected by the buyer and placed in the market basket are presented for purchase to the check out process of the participating retailer 24. This process may be a physical lane within a retail store, a collection of market basket items selected from a catalog and identified by the buyer at the time of check out, or the presentation of a script at a retail store, on-line or telephone based pharmacy counter, among other processes.

The process of using the retailer physical checkout lanes or the retailer physical pharmacy counter requires that market basket items be scanned or hand entered into the retailers store POS 26. The process of using catalog 18, on-line or telephone shopping requires that items be selected and identified by the shopping method and entered as items in the market basket.

Regardless of the method of shopping, all market basket item data, including price, quantity, taxes, point-of-purchase driven discounts are packaged into a single transaction and formatted according to the stores point-of-sale system message specifications. The single transaction must also include retailer identification information and buyer identification information, which at a minimum can include:

| | |
|---|---|
| 1. | Merchant ID |
| 2. | Store ID |
| 3. | Terminal ID |
| 4. | PAN—Primary Account Number |
| 5. | Timestamp |
| 6. | STAN—System Trace Audit Number |
| 7. | Line item detail <per unique market basket item> |

| | |
|---|---|
| a. | UPC |
| b. | Net price |
| c. | Tax |
| d. | Quantity |
| e. | Brief item description |

This transaction comes from the POS 26 to the store concentrator 30 to retailer switch 44 and then to the switch 16. The transaction data can include item data and customer identifier (financial transaction card number) data, and the like. Communication is via the retailers 24, store concentrator 30 and to the retailer switch 44. All of the retailers 24 are connected to the network, and data goes from the retailer switch 44 to the retainers 24, and then to another switch inside the merchant. The switch 16 utilizes the retailer switch 44 or to an internal retailer switch with communications to the retailer 24 being in a variety of methods, including but not limited to, ISO 8583 or XML data structures.

Transaction data is received from the originating retailer 24. The market basket transaction is directed from the market basket server 12 to the switch 16. The switch 16 formats the data into an XML data structure, from whatever retailer structure that was received, and transmits the translated XML structure to the market basket analysis server 12.

The market basket analysis server 12 utilizes the PAN to determine the catalogs 18 and purses for the buyer account. The buyer's personal information is not retrieved at any point in during adjudication or financial transaction processing. The buyer PAN relates one or more specific product catalogs to the market basket transaction.

If the buyer identifier, e.g., the account number of a financial transaction card (PAN) is not recognized by the switch 16, an error occurs and there is a rejection. If the PAN there is an error, the switch 16 returns a message to the originating retailer 24 that the transaction is declined.

The switch 16 matches the item data received in the market basket transaction, one item at a time. The switch 16 appends two indicators to each line item of the market basket. A flag is produced that communicates if the item is eligible or not eligible, and an indicator of the group (catalog) 18 is also determined to which the item belongs.

Upon completion of processing, each item in the market basket and totals by each group are used to package the market basket transaction and returned to the retailer 24 for processing. In another embodiment, the processed market basket transaction is returned to the switch 16.

Upon receipt of the processed market basket transaction the market basket analysis server 12 matches the buyer identifier to the financial transaction card issuer associated with the buyer identifier.

The switch 16 creates an XML-based payment authorization request message that includes financial processor 46 identification and merchant transaction identification information. This payment authorization is then sent to the financial processor 46. In various embodiments, ISO 8583, XML and NCPDPd.0 data structures are used for the authorization request messages between the switch 16 and the financial processor 46.

In various embodiments, the switch 16, (i) receives an authorization message back from the financial processor 46 or claims processor 54; (ii) creates a data log of authorized transactions based upon transaction identification number and (iii) creates an authorization message in the proper format to forward the message to the retailer 24.

Other embodiments of the invention will be apparent to those skilled in the art from consideration of the specification and practice of the invention disclosed herein. It is intended that the specification and examples be considered as exemplary only, with a true scope and spirit of the invention being indicated by the appended claims.

What is claimed is:

1. A method for multiple retailers to participate in restricted spend financial transaction card programs, comprising:
providing a restricted spend financial transaction card system that includes a adjudication processor system coupled to a retailer infrastructure, the adjudication processor system including a switch, a market basket analysis server and a process control server;
using the market basket analysis server to validate items in a market basket;
communicating content attributes of the market basket from the market basket analysis server to the switch; and
using the switch, market basket analysis server, a catalog management server and the process control server for adjudication.

2. The method of claim 1, further comprising:
providing authorization of a financial transaction for items in the market basket.

3. The method of claim 1, further comprising:
matching catalogs and financial account structure information with items in the market basket; and
paying for the items using a buyer's purse.

4. The method of claim 1, further comprising:
iteratively comparing market basket items to catalog(s).

5. The method of claim 1, further comprising:
processing a plurality of purses during an adjudication.

6. The method of claim 1, further comprising:
using the catalog management server to communicate with the product catalogs.

7. The method of claim 1, further comprising:
providing a financial processor that includes a issuer processor; and
using the financial processor to communicate with the switch.

8. The method of claim 2.1, further comprising:
communicating buyer account data with the market basket analysis server and financial transaction card numbers that are part of the financial processor.

9. The method of claim 1,
matching catalogs and financial account structure information with items in the market basket; and
paying for the items with a buyer's financial transaction card.

10. The method of claim 1, further comprising:
communicating between the catalog management server and product catalogs.

11. The method of claim 10, further comprising:
communicating a buyer's financial account data with the market basket analysis server and financial transaction card numbers that are part of the financial processor.

12. The method of claim 1, further comprising:
associating a restricted spend purse with a financial transaction card

13. The method of claim 1, further comprising:
communicating between a retailer product team with at least one of a product tables and price books; and
communicating between the retailer product team and the product tables and price books with the catalog management server.

14. The method of claim 1, further comprising:
collecting the market basket at the retailer infrastructure to obtain financial information from a buyer's financial transaction card; and
sending the market basket to the adjudication processor with either, (i) a retailer processing a purchase request, or (ii) the adjudication processor processing the purchase request.

15. The method of claim 1, further comprising:
communicating between the retailer infrastructure and the switch; and
pushing data to the adjudication processor; and
obtaining information about the accounts and catalogs.

16. The method of claim 15, further comprising:
using the market basket analysis server to analyze items in the market basket to obtain a result that is sent to the switch.

17. The method of claim 1, further comprising:
providing multiple authorizations for multiple purses.

18. The method of claim 1, further comprising:
coupling the switch to multiple financial processors when there are multiple authorizations.

19. The method of claim 1, further comprising:
using the switch to bifurcate multiple financial transactions; and
receiving authorization from multiple financial processors.

20. The method of claim 1, further comprising:
isolating a buyer's financial account information from a retailer.

21. The method of claim 1, further comprising:
isolating a retailer from details about multiple purses.

22. The method of claim 1, further comprising:
isolating a retailer from buyer demographics.

23. The method of claim 1, further comprising:
providing a benefits processor;
communicating between the benefits processor and the adjudication server.

24. The method of claim 23, further comprising:
contacting the benefits processor in real time; and
receiving a claim authorization.
